(19) United States
(12) Patent Application Publication
(10) Pub. No.: US 2008/0149364 A1
(43) Pub. Date: Jun. 26, 2008

(54) RIBBON CABLE

(75) Inventors: Harald Michael LUTSCH, Ottrau (DE); Rachid Ainceri, Darmstadt (FR)

Correspondence Address: SUGHRUE MION, PLLC, 2100 PENNSYLVANIA AVENUE, N.W., SUITE 800, WASHINGTON, DC, 20037, US

(73) Assignee: Yazaki Europe Ltd., Hertfordshire (GB)

(21) Appl. No.: 11/764,925

(22) Filed: Jun. 19, 2007

(30) Foreign Application Priority Data
Jun. 20, 2006 (DE) 102006028727.4-34

(51) Int. Cl. H01B 7/08

(52) U.S. Cl. 174/117 FF

(57) ABSTRACT

A ribbon cable 1 having a plurality of electric conductors 3 which are arranged in a plane 2 side by side and at a distance from one another and which are enclosed by an insulation 4 consisting of thermoplastic plastics, which insulation 4 comprises a first outer face 5 which extends at a distance from the plane 2 in which the conductors 3 are arranged side by side at a distance; a second outer face 6 which extends at a distance from the first outer face 5, wherein the distance between the two outer faces 5, 6 defines a thickness 7; at its lateral longitudinal ends 8, end portions 9 which connect the two outer faces 5, 6, which extend in the longitudinal direction of the ribbon cable 1, which are rounded and which, in the direction of the thickness 7, project beyond the outer faces 5, 6 and form rounded transitions towards the outer faces 5, 6.

The invention relates to a ribbon cable having a plurality of electric conductors which are arranged in a plane side by side at a distance from one another. Such ribbon cables can serve to transmit electric power and thus form a circuit.

In the case of ribbon cables which, for example, have to be connected to a connector or are to be introduced into a housing, there is—more particularly in the automotive sector—a need to provide a seal between the surface of the ribbon cable and the connector or housing into which it has to be introduced in order to prevent humidity from entering or any agents contained in the housing from leaving. As a rule, ribbon cables comprise a rectangular cross-section. Sealing such a rectangular cross-section is problematical because such ribbon cables are normally mass-produced, for example by extrusion from plastics in the form of an insulation into which the conductor is embedded. Furthermore, frequently the apertures through which the ribbon cable is introduced into the connector or housing form part of components which were also produced from plastics by injection moulding. Even slight inaccuracies mean that especially at the corners of the cable with the rectangular cross-section, secure sealing is not ensured. This is the case even if the ribbon cable is guided through a seal consisting of a harder material, which seal comprises the passage through which the ribbon cable passes. Therefore, the state of the art comprises a large number of suggestions for physically combining a seal and the ribbon cable, i.e. to produce a material-locking connection between the two in order to achieve the required leak-proofing. The seal is formed on to the end which enters an equipment housing or a connector or it is connected by glue to the ribbon cable in a material-locking way.

The complexity for such a procedure is high and such measures, if at all, are only suitable for mass-production purposes.

Such measures are not suitable for areas wherein cables with connectors have to be produced subsequently or have to be specially provided for retrofitting purposes.

US 2005/0003709 A1 for example describes a water-proof sealing assembly wherein the ribbon cable and the seal are provided with a coating of glue as a result of which the seal and the ribbon cable are closely connected to one another. The elastic seal itself then takes over the sealing effect relative to a connector housing for instance.

US 2002/0052141 A1 describes an assembly wherein the flexible seal is connected to a cable in a material-locking way, with the flexible seal then being received in a corresponding sealing portion of a housing. The sealing is directly formed on to the ribbon cable.

It is the object of the invention to provide a ribbon cable which is suitable for mass production and which, in addition, achieves a secure sealing effect relative to a passage in a housing directly or also relative to a seal which comprises a passage, without there being any need for any special intermediary treatment.

In accordance with the invention, the objective is achieved by providing a ribbon cable having

a plurality of electric conductors which are arranged in a plane side by side at a distance from one another and which are enclosed by an insulation consisting of thermoplastic plastics, which insulation comprises
a first outer face which extends at a distance from the plane in which the conductors are arranged side by side at a distance from one another;
a second outer face which extends at a distance from the first outer face, wherein the distance between the two outer faces defines a thickness;
at its lateral longitudinal ends, end portions which connect the two outer faces, which extend in the longitudinal direction of the ribbon cable, which are rounded and which, in the direction of the thickness, project beyond the outer faces and form rounded transitions towards the outer faces.

This measure ensures that the rounded end portions comprise a sufficient amount of material in order to achieve an accurate sealing effect even in a rectangular passage or in an inaccurately produced passage, i.e. the passage does not necessarily have to be adapted accurately to the shape of the ribbon cable.

As there is no need for any intermediary treatment between the component comprising the passage and the ribbon cable, for example by applying a glue or the like, the costs of assembling such a ribbon cable in a leak-proof are reduced considerably, even if the ribbon cable cooperates with a relatively stiff component (e.g. seals consisting or a harder material such as silicone) which comprises the passage for the ribbon cable. Of course, it is also possible for the ribbon cable to be used together with flexible seals comprising a passage. There is no need for both parts to be pre-treated in order to improve the leak-proof connection. More particularly, the rounded end portions ensure that, even if the ribbon cable in the seal receiving same is loaded in a lateral direction, i.e. in the direction of the greatest extension of its cross-section, there does not occur any displacement which would lead to leakages, because the rounded end portions make available a sufficient amount of material for achieving an effective and permanent seal.

In a preferred embodiment it is proposed that the rounded part of each end portion comprises a circular cross-section and a diameter which is greater than the thickness and that each transition is represented by a circular arch with a radius which is greater than 0.5 times the diameter. This measure achieves a particularly advantageous sealing effect. Alternatively, it is proposed that the rounded end portion comes close to a cross-section with an oval shape.

According to a further embodiment it is proposed that the insulation surrounding the conductors is produced by extrusion. By thus shaping the end portions of the ribbon cable, it is possible to use a method of producing same which allows mass production.

In connection with the ribbon cable in accordance with the invention, it is possible to use same together with a sealing assembly which is provided with a rectangularly shaped passage.

Alternatively, the ribbon cable can be used with a sealing assembly which comprises a sealing element which comprises a passage for the ribbon cable and which consists of a flexible material. A further possibility consists in that the inventive ribbon cable is used in a sealing assembly which comprises a sealing element which forms a passage for the ribbon cable which is provided with chambers which open towards the passage and which are filled with a gel. Such sealing assemblies, in connection with the inventive ribbon cable, ensure a hermetic and long-lasting seal which, even if force is applied in the lateral direction of the ribbon cable, maintains its sealing capacity.

In both the above-described embodiments, it is possible for the passage to be rectangular or it can be adapted to the shape of the ribbon cable.

Preferred embodiments of the invention are diagrammatically illustrated in the drawing wherein

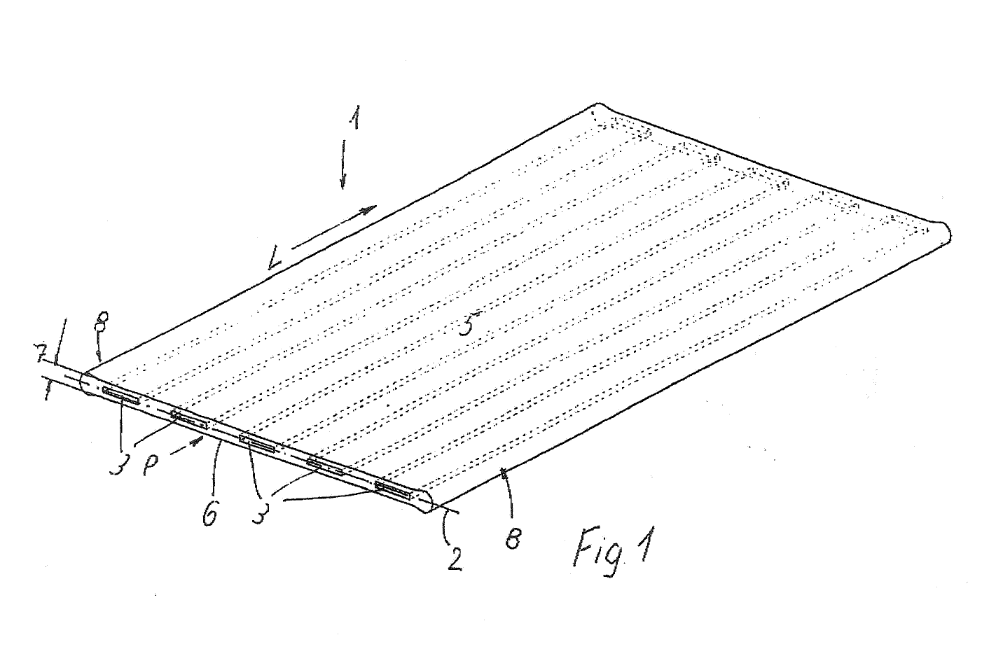

FIG. 1 is a perspective illustration of a portion of the ribbon cable in accordance with the invention.

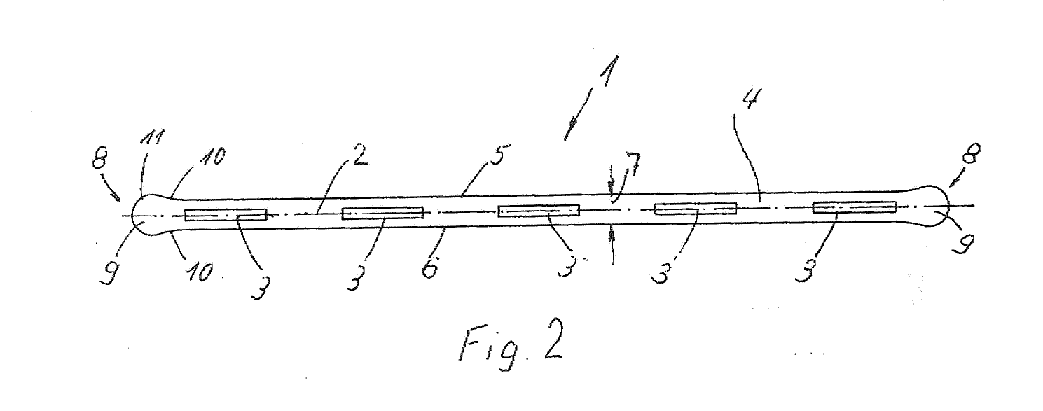

FIG. 2 is a view of the ribbon cable in the direction of arrow P.

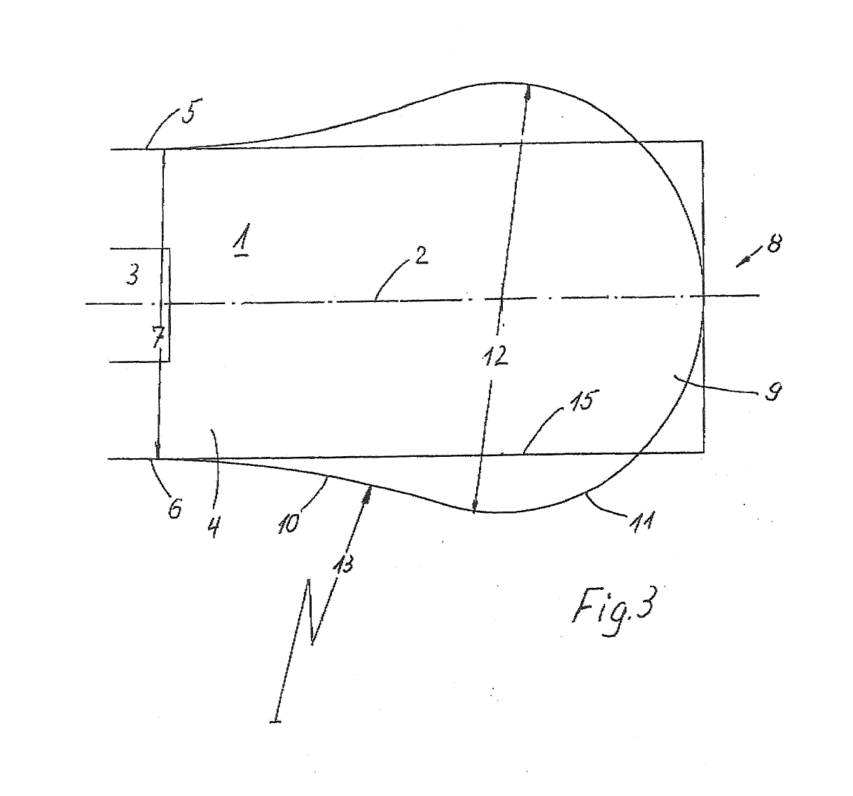

FIG. 3 shows an end portion at a lateral longitudinal end of the ribbon cable in an enlarged scale relative to a passage.

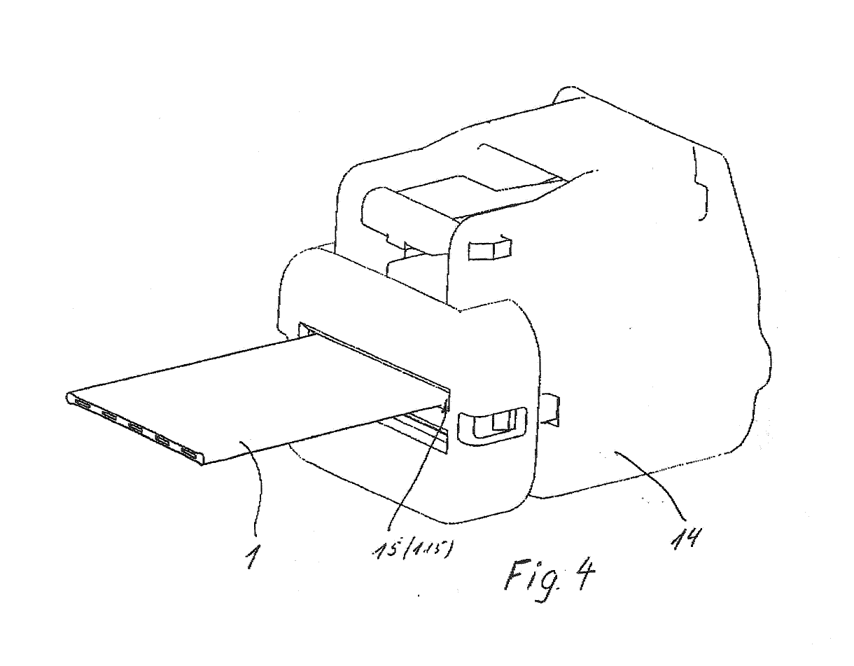

FIG. 4 is a perspective view of a male connector with an inventive ribbon cable portion associated therewith.

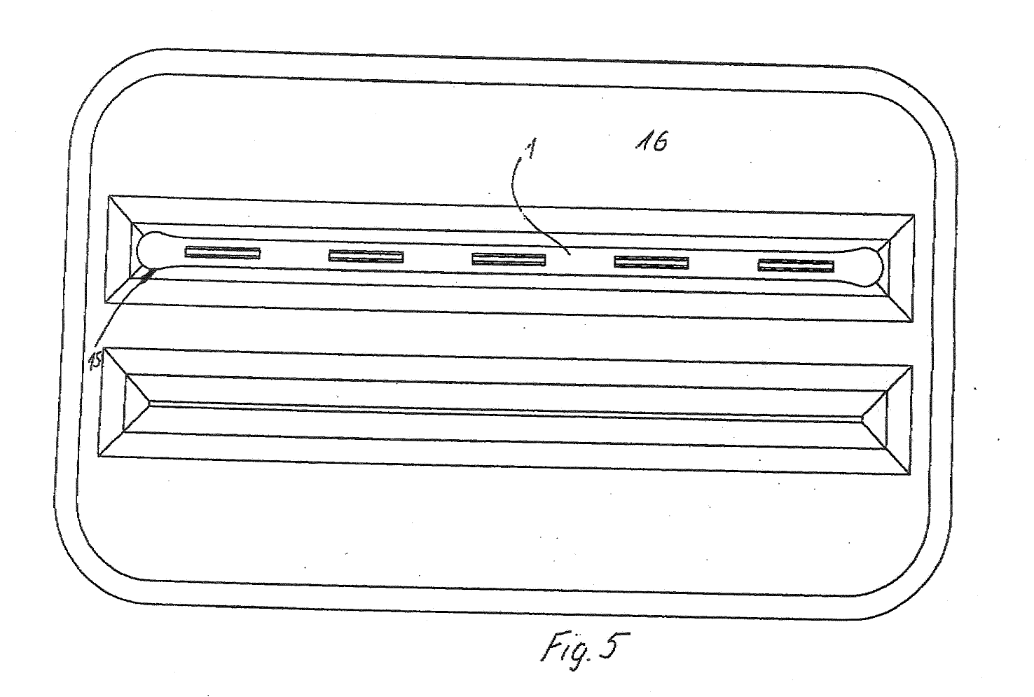

FIG. 5 shows a sealing element with a passage through which the ribbon cable is introduced.

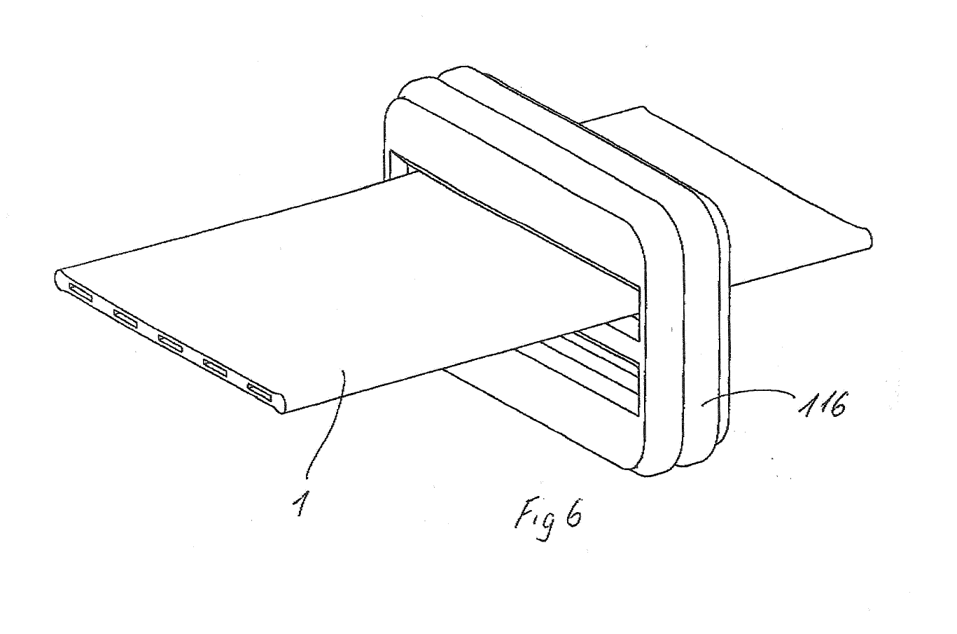

FIG. 6 shows a different embodiment of a sealing element with an associated ribbon cable.

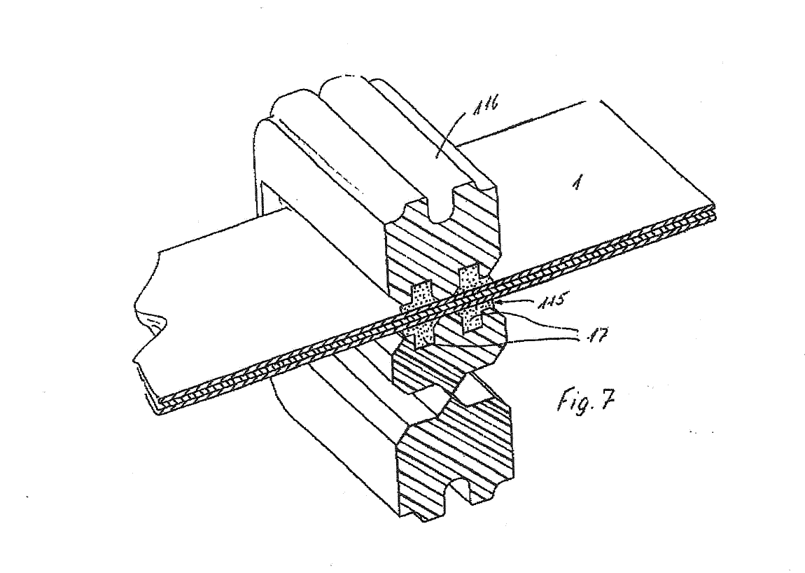

FIG. 7 is a longitudinal section through the assembly according to FIG. 6.

First, FIGS. 1 and 2 will be described jointly. They show a ribbon cable 1, with FIG. 1 showing a portion of same whose longitudinal direction has been given the reference symbol L. It is a ribbon cable 1 which comprises electric conductors 3 which are arranged in a plane 2 side by side, but at a distance from one another and which are enclosed by an insulation 4 consisting of thermoplastic plastics. The lateral longitudinal ends extending in the longitudinal direction L have been given the reference number 8. The longitudinal ends 8 are provided with end portions 9, whose shape will be explained in greater detail in connection with FIG. 3. The ribbon cable 1 comprises a first outer face 5 and a second outer face 6 which faces away from the first outer face 5, which first and second outer faces 5, 6 end in the end portions 9 extending between and at the lateral longitudinal ends 8. The two outer faces 5, 6 are arranged at a distance from one another defining a thickness 7 and are spaced from the plane 2 so as to extend in different directions. The two outer faces 5 and 6 extend substantially parallel relative to the plane 2, “substantially” meaning that as a result of the production process of extruding, there can occur variations in the thickness 7, so that there can exist differences relative to the remaining regions.

The end portions 9 each comprise a rounded part 11 and transitions 10 connecting the rounded part 11 to the first outer face 5 and to the second outer face 6 respectively.

FIG. 3 shows the design of one of the two end portions 9 at the lateral longitudinal ends 8 as compared to the diagrammatically illustrated passage 15 which can be associated with a seal, optionally also with a housing, into which there is introduced the ribbon cable 1, and which is rectangular in shape.

It can be seen that, relative to the portion having the first outer face 5 and the second outer face 6 and being positioned between the two longitudinal ends 8, and the thickness 7 formed by the two, the end portion 9 is thickened.

The end portion 9 comprises a rounded part 11 which is substantially circular and comprises a diameter 12 which is greater than the thickness 7, so that the end portion 9 of the ribbon cable 1 extends beyond the passage 15 with its upper and lower delimiting edge as illustrated in FIG. 3.

The rounded part 11 with the diameter 12, by means of a transition 10, changes into the first outer face 5 and the second outer face 6 respectively. The radius 13 which connects the first outer face 5 and the second outer face 6 to the rounded part 11 is dimensioned to be such that its dimension is greater than half the diameter 12. The transition 10 can be formed by a plurality of such curves formed by radii.

As a result of the relation formed between the rounded part 11 and the rectangular passage 15—because the ribbon cable 1 is shown in its stress-relieved condition—there is formed a free space which can be filled with the material overhang occurring as a result of the rounded part 11 with the transition 10 in that the outer contour of the ribbon cable 1 at the end portions 9 is adapted to the shape of the passage 15 and produces a leak-proof seal between the component comprising the passage 15 and the ribbon cable 1. This means that at the end portions 9 there is provided sufficient material in order to compensate for deviations in the passage 15 resulting from production inaccuracies. However, it is advantageous for the passage 1 to comprise a shape which is adapted at least approximately to the shape of the ribbon cable 1 in the region of the end portion 9. In any case, such a shape can be produced more advantageously than a shape provided from punched-out corners in the passage 15.

More particularly, such sealing problems can occur in a connector 14 as illustrated in FIG. 4. In addition to the connector 14, there is illustrated a ribbon cable 1 which is connected to same and which is introduced through a passage 15 and 115 respectively into the housing of the connector 14, with the passage 15 and 115 respectively being associated with sealing elements which are shown in FIGS. 5 to 7 for example.

FIG. 5 shows a sealing element 16 which consists of silicone for example and comprises a passage 15 through which the ribbon cable 1 is guided. The sealing element 16 constitutes for example a seal, on the one hand, between a housing of the male connector 14 as shown in FIG. 4 and, for example a cover containing the sealing element 16 and, on the other hand, between the ribbon cable 1 and the sealing element 16.

FIG. 6 shows a sealing element 116 in the form of a detail through which the ribbon cable 1 is guided. The sealing element 16 forms a passage 115 which is shown in greater detail in FIG. 7 which shows a longitudinal section through the assembly according to FIG. 6. It can be seen that the sealing element 116 produced from a silicone material for example, is provided with chambers 17 which additionally face the outer faces and the end portions of the ribbon cable 1, which are open towards the passage 115 and which can be effectively filled with a gel for example. The gel contacts the opposed faces of the ribbon cable 1 and has a hermetic sealing effect.

1. A ribbon cable comprising:
a plurality of electric conductors which are arranged in a plane side by side at a distance from one another and which are enclosed by an insulation made of thermoplastic plastics, which insulation comprises.
a first outer face which extends at a distance from the plane in which the conductors are arranged side by side at a distance from one another;
a second outer face which extends at a distance from the first outer face, wherein the distance between the two outer faces defines a thickness; and
at its lateral longitudinal ends, end portions which connect the two outer faces, which extend in the longitudinal direction of the ribbon cable, which are rounded and which, in the direction of the thickness, project beyond the outer faces and form rounded transitions towards the outer faces.

2. A ribbon cable according to claim 1, wherein the rounded part of each end portion comprises a circular cross-section and a diameter which is greater than the thickness and that each transition constitutes a curve including at least one circular arch with a radius which is greater than 0.5 times the diameter.

3. A ribbon cable according to claim 1, wherein the cross-section of the rounded end portion comes close to an oval shape.

4. A ribbon cable according to claim 1, wherein the insulation enclosing the conductors is produced by extrusion.

5. A ribbon cable according to claim 1, wherein the ribbon cable is used in a sealing assembly with a portion forming a passage for the ribbon cable, wherein the passage is rectangular in shape.

6. A ribbon cable according to claim 1, wherein the ribbon cable is used in a sealing assembly with a sealing element which comprises a passage for the ribbon cable and consists of a flexible material.

7. A ribbon cable according to claim 1, wherein the ribbon cable is used in a sealing assembly with a sealing element which forms a passage for the ribbon cable and which comprises chambers which are open towards the passage and are filled with a gel.

8. A ribbon cable according to claim 5 wherein the passage is rectangular or is adapted to the shape of the ribbon cable.
